(19) United States
(12) Patent Application Publication
(10) Pub. No.: US 2019/0110491 A1
(43) Pub. Date: Apr. 18, 2019

(54) METHOD AND APPARATUS FOR PRODUCING FOOD PRODUCT

(71) Applicant: NATURO PTY LTD, Coolum Beach, Queensland (AU)

(72) Inventor: Jeffrey John Hastings, Wootha, Queensland (AU)

(21) Appl. No.: 16/090,285

(22) PCT Filed: Mar. 31, 2017
(86) PCT No.: PCT/AU2017/050277

§ 371 Date: Oct. 1, 2018

(30) Foreign Application Priority Data
Apr. 1, 2016 (AU) 2016901217

(51) Int. Cl. A23B 7/005; A23B 7/04; A23L 19/00

(52) U.S. Cl. CPC A23B 7/0053; A23L 19/09; A23B 7/04

(57) ABSTRACT

A method for producing an avocado food product with a reduced instance of pathogens, the method comprising: (a) removing the pip and peel from an avocado leaving the flesh of the avocado; (b) macerating the avocado flesh; (c) exposing the avocado flesh to an atmosphere comprising steam for a predetermined time; wherein the steam is generated at or greater than about atmospheric pressure.

### TECHNICAL FIELD

The present invention generally relates to a method and apparatus for producing a food product comprising avocado and in particular for producing a food product comprising pulped avocado.

### BACKGROUND

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

Avocado is a popular and nutritious food that presents a challenge to the food industry due to its relatively short shelf life as a fresh fruit and its susceptibility to degradation due to refrigeration and freezing. Avocados that are refrigerated for an appreciable length of time will tend to discolour and develop undesirable flavours. Avocados that have been frozen may have their texture adversely effected and the taste and colour will typically degrade after thawing.

If the edible flesh (mesocarp) of the avocado is removed from the outer skin (pericarp) and/or the pip (endocarp), it will also very rapidly degrade in taste and texture. Degradation of the organoleptic properties of the avocado flesh tends to degrade even more rapidly if the fruit is macerated into smaller pieces or is pulped, due in part to the increased surface exposure of fruit prepared this way. Furthermore, extracting the edible flesh of the avocado may expose the flesh to pathogens such as listeria, salmonella and E. coli, which may make the fruit unsafe for human consumption.

Many uses of avocado in the food industry require a pulped avocado product, such as, for example, guacamole, and as a spread for sandwiches and toast. Pulped avocado may be difficult to prepare in the volume required by restaurants, as the avocado flesh has to be both removed from the skin and pip and pulped in the quantity immediately required so that the avocado does not become spoiled or attract pathogens. As such, pulped avocado may pose difficulties to prepare ahead of time in a restaurant service that may be beyond even sliced avocado.

Accordingly, there is a need to produce an avocado product comprising avocado flesh with pathogen loadings that are safe for human consumption. There is further need for a pulped avocado food product with pathogen levels that are safe for human consumption. Furthermore, there is a need for a pulped avocado food product with an improved shelf stability.

### BRIEF SUMMARY

According to an aspect the present invention provides a process for reducing the instance of pathogens in an avocado food product, the process comprising removing the pip and peel of an avocado to leave the flesh of the avocado to form the basis of the food product, exposing the flesh of the avocado to a turbulent atmosphere for a predetermined time wherein the atmosphere is greater than about atmospheric pressure and wherein the atmosphere is configured to heat the surface temperature of the avocado flesh to a temperature of between about 75° C. to about 120° C.

According to an aspect the present invention provides a method for producing an avocado food product with a reduced instance of pathogens, the method comprising: (a) removing the pip and peel from an avocado leaving the flesh of the avocado; (b) macerating the avocado flesh; (c) exposing the avocado flesh to an atmosphere comprising steam for a predetermined time; wherein the steam is generated at or greater than about atmospheric pressure.

Preferably the method further comprises: (d) drying at least some moisture from the surface of the avocado flesh.

Preferably the method further comprises: (e) cooling the avocado flesh.

Preferably steps (d) and (e) occur concurrently.

Preferably steps (d) and (e) are achieved concurrently by exposing the avocado flesh to refrigerated dehumidified air.

Preferably the method further comprises: (f) blending the avocado flesh to produce a pulp

Preferably the method further comprises: (g) freezing the avocado flesh.

Preferably the steam is generated at a pressure greater than 1 atm and less than about 6 atm.

Preferably the steam is generated at a pressure greater than 1 atm and less than about 1.5 atm.

Preferably the predetermined time is sufficient to raise the surface temperature of the avocado flesh to between about 75° C. to about 120° C.

Preferably the predetermined time is sufficient to raise the surface temperature of the avocado flesh to above about 95° C.

Preferably the predetermined time is sufficient to raise the surface temperature of the avocado flesh to above about 100° C.

Preferably the predetermined time is sufficient to reduce the pathogen loading of the avocado food product to safe levels for human consumption.

Preferably the pathogen is Listeria, salmonella or E. Coli.

Preferably a flavour agent is added to the water used to generate steam.

Preferably the flavour agent is selected from one or more of salts, derivatives of salts, sweetener, flavours, flavour enhancers, acids.

Preferably the flavour agent is added to the water used to generate steam such that the concentration of the flavour agent in the water used to generate steam is less than about 1.5% w/w.

Preferably the flavour agent is added to the water used to generate steam such that the concentration of the flavour agent in the water used to generate steam is between about 0.23% w/w and 1.5% w/w.

Preferably the flavour agent is added to the water used to generate steam such that the concentration of the flavour agent in the water used to generate steam is between about 0.75% w/w and 1% w/w.

Preferably the flavour agent is sodium citrate and/or sodium acetate.

Preferably the predetermined time is sufficient to reduce the instance of spoilage microbe loading in the avocado food product.

Preferably the predetermined time is sufficient to inhibit enzymatic browning of the avocado food product.

Preferably at step (b) the avocado flesh is macerated into random and irregular sized pieces.

Preferably at step (b) the avocado flesh is macerated into pieces with a volume of between about 0.2 cm³ to about 1.8 cm³.

Preferably at step (c) the avocado flesh is exposed on all sides to an atmosphere comprising steam.

Preferably at step (c) the avocado flesh is exposed to a turbulent atmosphere comprising steam.

Preferably at step (c) the avocado flesh is exposed to a turbulent atmosphere comprising steam configured such that the avocado flesh is exposed to a temperature distribution over the course of the predetermined time.

Preferably the temperature distribution is configured such that the avocado flesh is exposed to a lower temperature at the initial and/or final portions of the predetermined time.

Preferably the temperature distribution is configured such that the avocado flesh is exposed to an atmosphere comprising steam at a temperature of greater than about 100° C. over at least a portion of the predetermined time.

In an aspect the present invention provides An apparatus for producing a pulped avocado food product from avocado flesh with a reduced instance of pathogens, wherein the apparatus includes: a conveyor system to transport avocado flesh from a first end of a substantially elongate treatment hood through to a second end of the treatment hood over a predetermined period of time, wherein the treatment hood is configured to receive an atmosphere comprising steam and wherein the treatment hood is configured with an extractor at the first end or the second end of the treatment hood to remove a portion of the atmosphere comprising steam.

Preferably the treatment hood is configured with an extractor at both the first end and the second end of the treatment hood.

Preferably the steam is generated at or above atmospheric pressure.

Preferably the atmosphere containing steam is configured with a temperature distribution exists between the ends of the treatment hood.

Preferably the temperature distribution is adapted with a temperature at a middle region of the treatment hood that is higher than at least one of the first or second ends.

Preferably the temperature distribution is adapted with a temperature at a middle region of the treatment chamber that is higher than at both of the first and second ends of the treatment hood.

Preferably the atmosphere within the treatment hood is turbulent.

Preferably the temperature of the atmosphere within a portion of the treatment hood exceeds 100° C.

Preferably the pressure within a portion of the treatment hood exceeds atmospheric pressure.

Preferably the treatment hood is configured with a cross section transverse to the elongate dimension that has an outermost portion height that is about 50% to about 70% of the height of the central portion.

Preferably the treatment hood is configured with a cross section transverse to the elongate dimension that has an outermost portion height that is about 55% to about 65% of the height of the central portion.

Preferably the treatment hood is configured with a cross section transverse to the elongate dimension that has an outermost portion height that is about 59% to about 60% of the height of the central portion.

Preferably the treatment hood may be configured with one or more valves to regulate the pressure within the treatment chamber.

Preferably the valves are pressure relief valves.

In an aspect the present invention provides an avocado food product produced by the process of claim 1 and/or by the method of any one of claims 2 to 28 and/or by the apparatus of any one of claims 29 to 42.

### BRIEF DESCRIPTION OF FIGURES

Example embodiments should become apparent from the following description, which is given by way of example only, of at least one preferred but non-limiting embodiment, described in connection with the accompanying figures.

FIG. 1 illustrates a schematic plan view of an apparatus and a schematic side elevation according to the present invention;

FIG. 2 illustrates an isometric view of an apparatus according to the present invention.

### PREFERRED EMBODIMENTS

The following modes, given by way of example only, are described in order to provide a more precise understanding of the subject matter of a preferred embodiment or embodiments.

In the figures, incorporated to illustrate features of an example embodiment, like reference numerals are used to identify like parts throughout the figures.

Described herein is a method and apparatus for producing a food product comprising avocado. The method and apparatus involves treating avocados such that the pathogen loading of the avocados may be reduced to a level safe for human consumption. Surprisingly, by reducing the instances of pathogen to safe levels the avocado food product may display an increased shelf life without appreciable deterioration of organoleptic properties.

According to an embodiment, the method may involve peeling the avocados and removing the pip from the avocados such that only the edible flesh of the avocado remains. The avocados may then be macerated or otherwise reduced into small pieces. The small pieces may be of random irregular size and may have a volume of about 1 cm³±80%. The avocados may then be exposed to an atmosphere comprising steam for a predetermined period of time. Without wishing to be bound by theory, exposing the avocado to an atmosphere comprising steam may kill or substantially reduce in loading the pathogens that may be present on the avocado thereby making the avocado safe for human consumption. Still not wishing to be bound by theory, steam exposure may also incidentally kill or inhibit microbes that may lead to the spoiling of avocados and may also incidentally inhibit the enzymatic browning of avocados that may adversely effect the shelf life of avocados.

Common pathogens that may effect avocado flesh such as Listeria, Salmonella and E. Coli may by treated by the method and apparatus herein described.

In other embodiments, the method may further comprise removing moisture from the surface of the avocados exposed to atmosphere comprising steam and blending the avocados to produce a pulped product. The pulped avocado product produced may be substantially homogenous in nature or alternatively may be of a chunky texture with larger pieces embedded within a smooth and substantially homogenous pulp. Further embodiments may include freezing the pulped avocado for short or long term storage such that the avocado can be thawed and consumed at a later date. It has been surprisingly found that the pulped avocado product may have a shelf life of up to around 7 days after thawing without signification deterioration of the organoleptic properties of the avocado.

In certain embodiments, avocado flesh may be exposed to a temperature gradient or distribution over the predetermined time over which the avocado is exposed to an atmosphere comprising steam. The temperature gradient or distribution may be configured such that initial and final portions of the predetermined time the avocados are exposed to an atmosphere comprising steam are at a lower temperature than at a middle portion of the predetermined time. The surface temperature of the avocado flesh may similarly rise from an initial temperature at the beginning of the predetermined time to a maximum at the middle of the predetermined time before the temperature is decreased at towards the end of the predetermined time. Due to the slower transfer of heat from the atmosphere comprising heat to the core of the avocado flesh as opposed to its surface, the effect of the temperature gradient may be smoothed out such that the temperature of the core of the avocado rises somewhat linearly over the course of the predetermined time, although some plateauing temperature may occur as the temperature of the avocado approaches the temperature of the atmosphere. Otherwise stated, the surface temperature may respond appreciably faster to the conditions of the atmosphere comprising steam than the core of the avocado. Accordingly, the core temperature of the avocado may be appreciably lower over a period of the predetermined time, or for the full extent of the predetermined time.

In further embodiments avocado flesh may be exposed to an atmosphere comprising steam that has an essentially constant temperature distribution over the predetermined time. In such embodiments, the core temperature of the fruit may increase somewhat linearly over the course of the predetermined time, although some plateauing of temperature may occur with declining heat transfer rates as the temperature of the avocado approaches the temperature of the atmosphere comprising steam.

The temperature of the atmosphere comprising steam may be configured such that the surface temperature of the avocado flesh is raised to between about 75° C. to about 120° C. over the course of the predetermined time. In other embodiments, the surface temperature of the avocado is increased to above about 90° C. or about 95° C. for a portion of the predetermined time. In other embodiments, the surface temperature of the avocado is increased to above about 100° C. for a portion of the predetermined time. Without wishing to be bound by theory, it is thought that raising the temperature of the avocado flesh to elevated temperatures such as this may have benefits in reducing the pathogen loading of the avocado and may incidentally also have benefits in inhibiting microbes and enzymes that may lead to the spoilage of the avocado. Elevated temperatures may also shorten the period of the predetermined time required to reduce the pathogen loading of the avocado. Such shortening of the predetermined time may simplify the present method and apparatus required to achieve the present method. Elevated temperatures and a shorter predetermined time may also allow for the avocados to be treated of pathogens whilst exposing the avocado to heat for a shorter overall period, which in turn may prevent the avocado flesh from becoming “cooked” or “blanched” by over exposure to heat in a manner that may degrade the organoleptic properties of the fruit. In other embodiments, the temperature of the atmosphere comprising steam may be configured such that the temperature of the avocado is increased to a surface temperature of above 80° C. for a time of at least about 1.5 minutes. In other embodiments, the temperature gradient may be configured such that the surface temperature of the avocado flesh is increased to above 80° C. for a time of between 2.5 to about 3.5 minutes.

The pulped avocado food product may display substantially the same organoleptic properties as a freshly pulped avocado. To allow for a pulped food product with these organoleptic properties, the temperature of the atmosphere comprising steam over the predetermined time is configured such that the avocado does not overheat in a manner that would substantially affect its organoleptic properties. The temperature of the atmosphere comprising steam may be configured so that the flesh of the avocado is not “cooked” or “blanched” such that the taste and mouth feel of the avocado is effected. Adjustment of both the period of the predetermined time and the temperature of the atmosphere comprising steam, as well as the temperature distribution if present, may allow the pathogen loading of the avocados to be reduced without appreciably effecting the organoleptic properties of the avocado whilst also extending the shelf life of the avocado food product.

In certain embodiments, the method may involve steam generated at a pressure of 1 atmosphere or greater for exposing the avocado to an atmosphere comprising steam for a predetermined time. In certain embodiments, the steam may be generated at a pressure between greater than about 1 atmosphere to about 6 atmospheres of pressure. In other embodiments, steam may be generated at pressures greater than between about 1 atmosphere and less than about 1.5 atmospheres of pressure.

By using steam which has been generated at pressures at above 1 atmosphere, the atmosphere comprising steam may be above temperatures of 100° C. (assuming a standard atmosphere of pressure at sea level) or higher, and as such the avocado may be exposed to temperatures of above 100° C. or higher. Exposing the avocados to high temperatures of above about 100° C. or higher may allow for avocados to quickly be brought up to a heat sufficient to reduce pathogens present on the avocados and may also allow for the heat of the avocados to be brought to temperatures of above 100° C. or higher for a portion of the predetermined time. Exposing the flesh of the avocado to temperatures of above 100° C. may have additional benefits for treating the avocados such that certain microbes or enzymes that may detrimentally affect the organoleptic properties of the fruit are inhibited.

It will be appreciated that providing steam at atmospheric pressure or even above atmospheric pressure may not result in an atmosphere comprising steam with a temperature of 100° C. or above as may be expected. Other components of the atmosphere, for example ingress air, may temper the steam and reduce temperature to below the temperature of 100° C. which may otherwise be expected from steam produced at atmospheric pressure. General heat loss from the atmosphere comprising steam to the ambient atmosphere may similarly contribute to temperature reductions to less than 100° C. Furthermore, even if the atmosphere comprising steam was at 100° C., heat transfer from the steam to the avocado flesh may diminish significantly as the avocado flesh approaches the temperature of the steam such that long predetermined times may be required to reach a fruit temperature of even 80° C. and even more so 90° C. or 95° C. Extremely long predetermined times may be required for the avocado flesh to approach the theoretical maximum temperature of 100° C. due to the diminishing temperature differential between the avocado and the steam generated at atmospheric pressure. Very long exposures to heat may degrade organoleptic properties of the avocado and may require larger and more expensive equipment to carry out the method. It has been found that by exposing avocado flesh to an atmosphere comprising steam generated at a pressure above atmospheric, and more specifically at temperature of above 100° C., the temperature of the avocado flesh may be raised relatively quickly to the elevated temperatures required to reduce the incidence of pathogen on the avocado flesh without overexposing the avocado flesh to heat for a long period of time such that organoleptic properties are degraded. Furthermore, it has been found that the high pressure environment itself may also contribute to the reduction of pathogen loading whilst extending the shelf life of the avocado food product without appreciably effecting the organoleptic properties.

It has been found that exposing the avocado flesh to an atmosphere comprising steam rather than a dry heat may be preferential for reducing the pathogen loading while also preserving the organoleptic properties of the fruit. Dry heat may be applied, for example by an oven or some other means. Surprisingly, the “wet” heat of the steam may decrease pathogen loading to safe levels while also producing an avocado food product with an extended shelf life, which does not appear to be the case for avocados exposed to dry heat.

However, exposing the avocado pieces to an atmosphere comprising steam may lead to the formation of condensation on the surface of the avocado flesh. The presence of moisture on the surface of the avocado flesh may extract natural oils and juices from the fruit which may adversely effect the organoleptic properties of the fruit. In some embodiments, the surface of the avocado must be sufficiently dried in order to be frozen for storage. Accordingly, moisture present on the surface of the avocado flesh may be removed by a drying step to minimise the length of time that the moisture is present. Drying may be achieved by any suitable means, including by forced draught.

After the avocado pieces have been exposed to the atmosphere comprising steam for the predetermined time, the avocado flesh may be at an elevated temperature. If the flesh of the avocado remains at elevated temperatures for appreciable lengths of time, organoleptic properties of the fruit may be adversely effected. In some embodiments, a cooling step may be used to minimise the time that the fruit is at elevated temperatures following the exposure to the atmosphere comprising steam. The cooling step may be achieved by any suitable means, including refrigeration or by incidence on chilled surfaces such as a chilled conveyor belt. In some embodiments, exposure to ambient conditions may be sufficient to cool the temperature of the avocado without appreciable degradation of organoleptic properties.

In some embodiments, the drying step and the cooling step may occur concurrently. For example, drying the fruit by forced draft may also serve to reduce the temperature of the fruit. In a preferred embodiment, the avocado may be dried and cooled concurrently by exposure to dehumidified air that had been chilled (refrigerated). This refrigerated dehumidified air may be formed by first passing air through a dehumidifiying step followed by passing air through a refrigerating step. Refrigerated air that has not been dehumidified is typically saturated or near saturated, and thus may not encourage the removal of moisture from the avocado surface. Dehumidified and subsequently refrigerated air may be unsaturated, and may thus encourage transfer of the moisture from the surface of the avocado to the fruit. Advantageously, transfer of moisture from the avocado surface to the refrigerated dehumidified air may contribute to the cooling of the avocado by the latent heat transfer associated with evaporation of the moisture. Accordingly, the required cooling load may be achieved using dehumidified refrigerated air with a warmer temperature compared to refrigerated air that had not been dehumidified. In an embodiment, it was found that dehumidified refrigerated air at 70% RH and 5° C. may be able to sufficiently cool and dry the avocado following exposure to the atmosphere comprising steam, though other arrangements are equally permissible depending on process conditions such as the temperature of the atmosphere comprising steam. In other embodiments, dehumidified air that has not bee refrigerated may be used to dry the avocados and may also have a concurrent cooling effect on the avocados.

It has been found that exposing all or the majority of the surface area of the avocado flesh to the atmosphere comprising steam is preferable for reducing the pathogen loading of the fruit without appreciably effecting the organoleptic properties. To facilitate good contact between the surface of the fruit and the atmosphere comprising steam, pieces of avocado flesh may be arranged within the atmosphere comprising steam in a manner that minimises or reduces contact with other prices of avocado flesh. It may also be preferable to seat the avocado pieces on a perforated surface such a grate conveyor to allow to passage of steam to a surface of the fruit that would otherwise be obstructed.

It has also been found that providing for an atmosphere comprising steam that flows in a turbulent manner may improve the effectiveness of the method in reducing the instance of pathogens on the avocado flesh. In some embodiments, fans may be used to increase the turbulence of the atmosphere comprising steam and increase vortices and eddies in the atmosphere comprising steam.

It has also been found that the quality of the water used to generate the steam may improve the effectiveness of the method. The water should be of potable quality, however, it may be preferable to use distilled water and even more preferred to use purified water.

In some cases, some consumers reported that avocados exposed to an atmosphere comprising steam as described hereinbefore displayed certain taste characteristics that may have deviated slightly from the usual organoleptic properties of fresh avocado, such as a mild smoky flavour. It was surprisingly found that the addition of one or more flavour agents to the water used to generate the steam mitigated or substantially removed these taste characteristics to the consumers that reported them. The flavour agents may be selected from those known well known in the field of food science including flavours, flavour enhancers, sweeteners, salts, salt derivatives and acids. In some embodiments flavours extracted from natural sources such as lemon essence may be used as a flavour essence. In some embodiments acids such as vinegar or citric acid may be used as a flavour agent. In some embodiments salts such as sodium chloride, sodium citrate or sodium acetate may be used. In some embodiments salt derivatives may be used. Preferably the concentration of the flavour agents in the water used to generate steam may be less than 1.5% w/w. Preferably the concentration of the flavour agents in the water used to generate steam may be between about 0.25% w/w and 1.5% w/w, or between about 0.75% w/w and 1% w/w. It is to be understood that the exact concentration of the flavour agent in the water used to generate steam will depend on the individual agent selected. It is preferred that the flavour agent be edible. It is preferred that the flavour agent does not have a corrosive effect when added to the water used to generate steam. For example, although sodium chloride was found to be effective as a flavour agent, it may not be preferred due to the corrosive effect it may have in solution with the water used to generate steam. In an example embodiment, it was found that adding salts including sodium citrate, sodium acetate or sodium chloride to the water used to generate steam substantially mitigated certain taste characteristics deviating from fresh avocado as reported by some consumers when present in the water used to generate steam in concentrations less than about 1.5% w/w such as between about 0.25% w/w and 1.5% w/w, or between about 0.75% w/w and 1% w/w. In some embodiments, mixtures of flavour agents may be added to the water used to generate steam.

The described method is configured to reduce the pathogen loading of the avocado flesh, it has been surprisingly found that the method may also aid in preserving the organoleptic properties of the avocado and may also extend the shelf life of the avocado food product produced considerably.

Once the fruit has been treated for pathogens, it may be blended to form a pulp. This may be done by any standard blending method, such as ribbon blending. Pulp may then be placed into packaging for storage. The stored pulp may be refrigerated or frozen if desired. The shelf life of the refrigerated pulp may be about 7 days. Depending on the quality of the packaging, the frozen pulp may have a shelf life of 1 to 2 years. Furthermore, once the frozen pulp is thawed, it may have a shelf life under refrigeration of up to about 7 days. The present method allows for an avocado food product that may be frozen by conventional means, and does not require the avocado flesh to undergo IQF freezing, although the IQF process may be used.

Also described herein is an apparatus suitable to achieve the method as hereinbefore described. The apparatus may include a treatment hood 3 to receive and contain an atmosphere comprising steam. The treatment may be elongate having an entry region 17 at a first end, a middle region 16 and an exit region 18 at a second end, and may be configured with a conveyer system 13 that may traverse the length of the elongate treatment hood 3 or part thereof, thereby tracking avocado placed on the conveyor system 13 through the treatment hood 3 over a predetermined time such that the tracked avocado is exposed to the atmosphere comprising steam in the hood 3. Otherwise stated there may be provided a conveyor system 13 adapted to receive pieces of avocado flesh, such that the avocado will be transported from one end 17 of the elongate treatment hood 3 to the other end 18 of the hood 3, the conveyor system 13 being arranged along a long axis of the elongate hood 3. The conveyor system 13 may be of a perforated or grate design to allow steam to contact the surface of the avocado flesh incident on the conveyor 13.

Steam may be provided to the treatment hood 3 from a boiler 12. The boiler 12 may be arranged underneath the treatment hood 3 and may be configured to generate steam upwardly and into the treatment hood 3. In some embodiments, steam may be generated at pressures at or greater than atmospheric. In some embodiments, steam may be generated by channelling air heated to up to 1500° C. through a water bath thereby boiling the water under pressure. This air may be heated by combustion.

Depending on the pressure at which the steam is generated, valves may be installed on the treatment hood to control the pressure within the hood. In some embodiments, pressure relief valves may be installed on the hood.

In some embodiments, one or both of the ends 17,18 of the elongate hood 3 may be equipped with an extractor 4 to extract the atmosphere comprising steam from the treatment hood 3. In a preferred embodiment, the extractor 4 may involve a condensation tower 4 that rises from the hood 3. The condensation tower 4 may be configured to collect a portion of steam from the hood 3, and condense a portion of this steam into water that may be returned to the water bath of the boiler 12 to be re-boiled and returned to the treatment hood 3 as steam.

In other embodiments, an extractor 4 such as a condensation tower 4 may be equipped to both ends 17,18 of the treatment hood 3, such that steam is being removed and condensed at both ends 17,18 of the treatment hood 3. The removal of steam from both ends 17,18 of the hood 3 may cause the atmosphere comprising steam to flow towards the ends 17,18 of the hood 3, as a pressure gradient may exist which falls towards the low pressure zones caused by condensing steam. The pressure gradient may in turn cause a temperature gradient due to the temperature and pressure relationship of the steam. The existence and prominence of such a gradient/distribution may depend on factors such as the pressure at which the steam is generated, the rate of addition of steam into the atmosphere of the treatment hood and the rate of removal of steam by the extractor 4.

If the treatment hood 3 is configured with an extractor 4 at both ends 17,18, the pressure and temperature distribution may thereby be configured to fall towards the ends 17,18 of the treatment hood 3 across the span of the long axis of the elongate hood. Such an arrangement may lead to a localised high temperature and pressure region at a portion of the treatment hood 3, for example at about a middle region 16 of the treatment hood 3, with temperatures falling in a direction along the long axis of the hood 3 away from the high temperature region and toward the ends 17,18 of the hood 3. Similarly, if the treatment hood 3 is configured with a single extractor 4, pressure and temperatures may be configured in a distribution to falls towards the extractor 4.

In some embodiments, condensation towers 4 at each end 17,18 of the treatment hood 4 may cause only a slight drop in the temperature of the atmosphere comprising steam near the condensation towers 4. In such an embodiment, the temperature may increase rapidly from about 90° C. at both ends 17,18 of the hood 3 to between about 101° C. to about 104° C. at the middle region 16 of the hood 3. For a hood 3 that is several metres long, the temperature may rise from about 90° C. to between about 101° C. to 104° C. within about 300 mm from the ends 17,18 of the hood 3, such that the temperature gradient of the atmosphere along the length of the hood is of a ‘table top’ shape. In such an embodiment, the surface temperature of the avocado may be of a bell curve nature across the length of the hood, quickly rising from ambient to about 90° C. at the entry region 17 of the hood 3 to about 97° C. at the middle region of the hood 3 before falling to about 93° C. at the exit region 18 of the hood 3. The core temperature of the avocado flesh may increase from ambient at the entry region 17 of the hood 3 to about 90° C. at the exit region 18 of the hood 3 in an approximately linear manner.

In certain embodiments, the effect of the extractors 4 on the temperature and pressure distributions may be relatively low, such that the temperature distribution of the atmosphere along the length of the hood 3 may be substantially constant.

By providing for an extractor 4 at one or both ends 17,18 of the treatment hood 3, a pressure gradient/distribution may be present across the length of the treatment hood 3 which may in turn induce a flow pattern to be imposed on the atmosphere comprising steam over the length of the hood 3. The flow pattern may be configured to aid in the promotion of turbulent flow, which may improve the efficiency of the process as herein before described.

The hood 3 may also be configured with a cross section taken transverse to the long axis (elongate dimension) of the hood 3 that is pitched, with a peak at the upper central portion 10 of the hood 3 falling towards the outermost portions 11 of the of the hood 3. In certain embodiments, the outermost portions 11 of the hood 3 may have a height that is around 50% to around 70% of the height at the central portion 10 of the hood 3. In an embodiment the outermost portions 11 of the hood 3 may have a height that is around 55% to around 65% of the height of the central portion 10 of the hood 3. In an embodiment the outermost portions 11 of the hood 3 may have a height that is around 59% or around 60% of the height of the central portion 10 of the hood 3. The central portion 10 of the hood 3 may be in the form of a sharp apex that falls linearly towards both outermost portions 11 of the hood 3 such that the upper part of the hood 3 is triangular. By this arrangement, condensation collecting on the inside surface of the hood 3 may be encouraged to fall towards the outermost regions 11 under the encouragement of the pitched hood 3. The outermost region 11 of the hood 3 may span beyond the conveyor system 13 such that the condensate encouraged toward the outermost regions 11 is less likely to dip on the avocados, thus minimising the moisture collecting on the surface of the avocados. It has also been found that such a cross section may further promote turbulent flow compared to a cross section with constant height.

In some embodiments, the treatment hood 3 may not be enclosed, for example, at the ends 17,18 of the hood 3 where the conveyor system 13 enters and exits the hood 3. In such an embodiment, the extractor(s) 4 may be configured such that the steam atmosphere preferentially exits the treatment hood through the extractor(s) 4 rather than through the non-enclosed ends 17,18 of the hood 3, thereby preventing or reducing steam egress from the hood 3.

The provision of an atmosphere comprising steam generated at a pressure greater than an atmosphere may increase the flow of the atmosphere through the hood 3 compared to steam generated at atmospheric pressure or lower. Steam generated at greater than atmospheric pressure may also provide from temperatures greater than 100° C. and pressures greater than 1 bar, which may increase the mortality rate of some pathogen compared to steam at atmospheric temperatures or less.

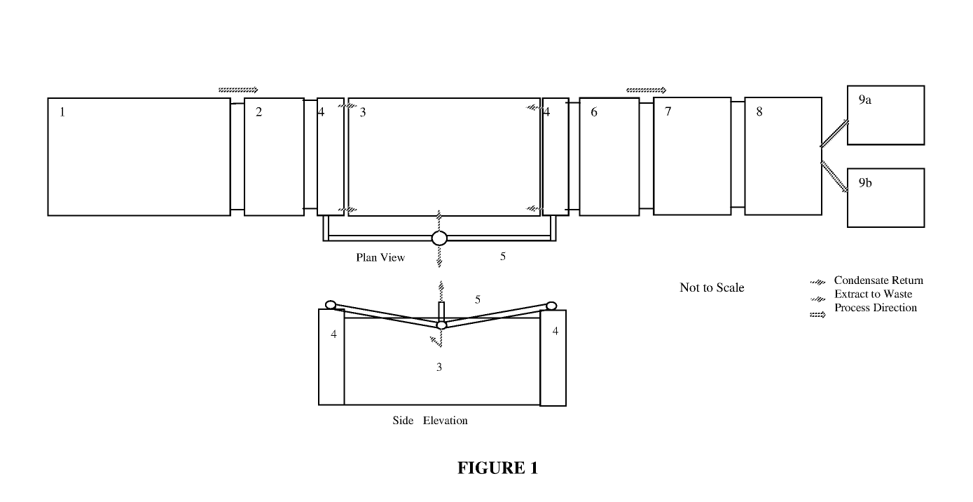

With reference to FIG. 1, the treatment hood 3 may be arranged on a production line with other apparatus as required to achieve the method as hereinbefore described. A preparation station 1 may be provided for workers to manually remove the pip and peel from an avocado, thereby leaving only the avocado flesh. The avocado flesh may then be sized into pieces at a sizing station 2 and placed on the conveyor system 13 at one end 17 of the treatment hood 3. Once the conveyor system 13 has tracked the avocado flesh through the length of the treatment hood 3 and exposed the avocado to the atmosphere comprising steam to reduce the pathogen loading on the avocado flesh to safe levels, the avocado flesh may be placed in a conditioning station 6 where moisture may be removed from the surface of the avocado, and where the avocados may be cooled. In some embodiments, the conveyor system may continue from the exit region 18 of the treatment hood 3 through the conditioning station 6, ultimately depositing the treated, dried and cooled avocados into a blender 7 or pulper such as a ribbon blender. The avocado flesh is then blended into the desired consistency to produce an avocado food product. For example, in a ribbon blender, the avocado may be processed for a short amount of time to produce a chunky consistency or for a long amount of time to produce a smooth consistency. The avocado may then be placed in a suitable package at a packaging station 8. The packaged avocado food product may then be stored under refrigeration 9a or sent to a freezer 9b to be frozen by conventional means for storage.

Also shown in FIG. 1 is an extraction means in the form condensing towers 4 rising from the treatment hood 3 at both ends of the treatment hood 3. The condensation towers 4 may collect steam that has flowed through the treatment hood 3 and may condense a portion of the steam into water. Ducting 5 from the condensation tower 4 may be arranged with a fall towards a boiler system (not shown) to encourage the condensed liquid to flow towards the boiler system to be re-boiled into steam and returned to the treatment hood 3. By configuring the rate of condensation within the condensation towers 4 and thereby the pressure drop at the ends 17,18 of the hood 3, flowrate of the atmosphere comprising steam through the hood may increased, particularly in combination with steam generated at a pressure greater than the ambient atmosphere. High flowrates through the hood may encourage a turbulent flow regime which may involve vortexing or otherwise non-streamlined flow which has been found to improve the efficiency of the process.

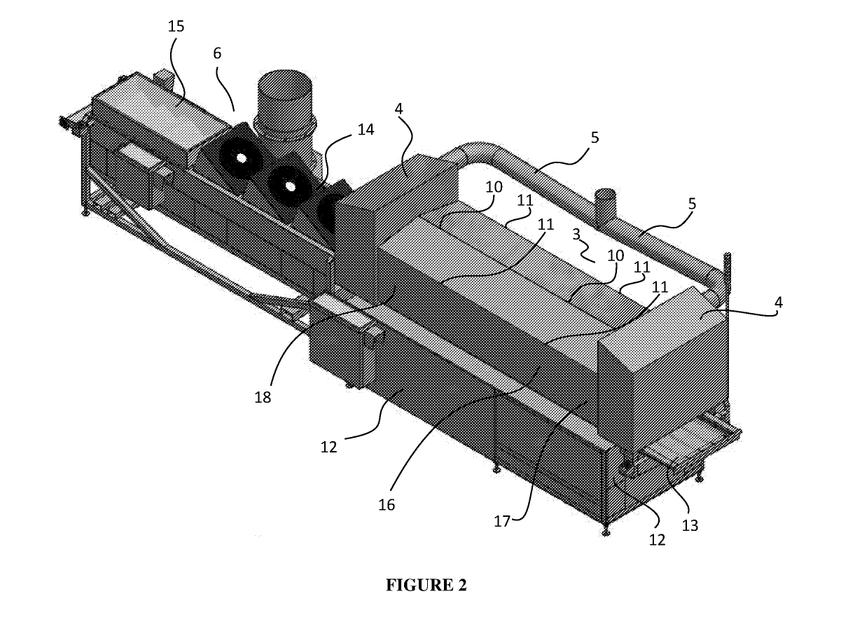

FIG. 2 shows an isometric representation of an embodiment of the treatment hood 3 arranged adjacent to the conditioning station 6. In this embodiment, the conveyor system spans both the treatment hood 3 and the conditioning station 6 so that the avocado pieces on the conveyor are transported continuously through the treatment hood and the conditioning station. In the shown embodiment, the conditioning station includes a separate drying section 14 in the form of fans and a cooling section 15 in the form of electric refrigeration. However, it the fans of the cooling station may also contribute to cooling the avocados and the refrigeration system may also contribute to drying the avocados. In other embodiments, the conditioning station 6 may concurrently cool and dry the avocados, for example, by exposing the avocados to dehumidified refrigerated air as hereinbefore described.

It has been found that the described apparatus may process avocados according to the described method to produce a pulped avocado food product with a reduced instance of pathogens. Specifically, the apparatus and method can achieve a Listeria mortality with a 6 log kill. Surprisingly it has been found that the method and apparatus incidentally extends the shelf life of the avocado appreciably, producing a food product that remains with a shelf stability of about 7 days under refrigeration. Also surprisingly, the method and apparatus allows for the avocado product to be frozen by conventional means rather than IQF without appreciable effects on the organoleptic properties.

Many modifications will be apparent to those skilled in the art without departing from the scope of the present invention.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose. Terms such as “front” and “rear”, “inner” and “outer”, “above”, “below”, “upper” and “lower” and the like are used as words of convenience to provide reference points and are not to be construed as limiting terms.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

1. A process for reducing the instance of pathogens in an avocado food product, the process comprising removing the pip and peel of an avocado to leave the flesh of the avocado to form the basis of the food product, exposing the flesh of the avocado to a turbulent atmosphere for a predetermined time wherein the atmosphere is greater than about atmospheric pressure and wherein the atmosphere is configured to heat the surface temperature of the avocado flesh to a temperature of between about 75° C. to about 120° C.

2. A method for producing an avocado food product with a reduced instance of pathogens, the method comprising:
(a) removing the pip and peel from an avocado leaving the flesh of the avocado;
(b) macerating the avocado flesh;
(c) exposing the avocado flesh to an atmosphere comprising steam for a predetermined time;
wherein the steam is generated at or greater than about atmospheric pressure.

3. The method according to claim 2, wherein the method further comprises:
(d) drying at least some moisture from the surface of the avocado flesh.

4. The method according to claim 2, wherein the method further comprises:
(e) cooling the avocado flesh.

5. The method according to claim 2, wherein steps (d) and (e) occur concurrently.

6. (canceled)

7. The method according to claim 2, wherein the method further comprises:
(f) blending the avocado flesh to produce a pulp.

8. The method according to claim 2, wherein the method further comprises:
(g) freezing the avocado flesh.

9. (canceled)

10. The method according to claim 2, wherein the steam is generated at a pressure greater than 1 atm and less than about 1.5 atm.

11. The method according to claim 2, wherein the predetermined time is sufficient to raise the surface temperature of the avocado flesh to between about 75° C. to about 120° C.

12-15. (canceled)

16. The method according to claim 2, wherein a flavour agent is added to the water used to generate steam.

17. The method according to claim 16, wherein the flavour agent is selected from one or more of salts, derivatives of salts, sweetener, flavours, flavour enhancers, acids.

18-25. (canceled)

26. The method according to claim 2, wherein at step (c) the avocado flesh is exposed on all sides to an atmosphere comprising steam.

27-30. (canceled)

31. An apparatus for producing a pulped avocado food product from avocado flesh with a reduced instance of pathogens, wherein the apparatus includes:
a conveyor system to transport avocado flesh from a first end of a substantially elongate treatment hood through to a second end of the treatment hood over a predetermined period of time, wherein the treatment hood is configured to receive an atmosphere comprising steam and wherein the treatment hood is configured with an extractor at the first end or the second end of the treatment hood to remove a portion of the atmosphere comprising steam.

32. The apparatus according to claim 31, wherein the treatment hood is configured with an extractor at both the first end and the second end of the treatment hood.

33. The apparatus according to claim 31, wherein the steam is generated at or above atmospheric pressure.

34. The apparatus according to claim 31, wherein the atmosphere containing steam is configured with a temperature distribution exists between the ends of the treatment hood.

35. The apparatus according to claim 31, wherein the temperature distribution is adapted with a temperature at a middle region of the treatment hood that is higher than at least one of the first or second ends.

36-39. (canceled)

40. The apparatus according to claim 31, wherein the treatment hood is configured with a cross section transverse to the elongate dimension that has an outermost portion height that is about 50% to about 70% of the height of the central portion.

41. (canceled)

42. The apparatus according to claim 31, wherein the treatment hood is configured with a cross section transverse to the elongate dimension that has an outermost portion height that is about 59% to about 60% of the height of the central portion.

43. The apparatus according to claim 31, wherein the treatment hood may be configured with one or more valves to regulate the pressure within the treatment chamber.

44. The apparatus according to claim 43, wherein the valves are pressure relief valves.

45. An avocado food product produced by the process of claim 1.
